(19) United States
(12) Patent Application Publication
(10) Pub. No.: US 2020/0136302 A1
(43) Pub. Date: Apr. 30, 2020

(54) ELECTRICAL CONNECTOR CAGE ASSEMBLY, ELECTRICAL CONNECTOR, AND ELECTRONIC APPARATUS

(71) Applicant: ALL BEST PRECISION TECHNOLOGY CO., LTD., Taoyuan City (TW)

(72) Inventor: Haven Yang, TAOYUAN CITY (TW)

(21) Appl. No.: 16/224,763

(22) Filed: Dec. 18, 2018

(30) Foreign Application Priority Data
Oct. 30, 2018 (TW) 107138293

(51) Int. Cl. H01R 13/518

(52) U.S. Cl. CPC H01R 13/518

(57) ABSTRACT

An electrical connector cage assembly includes a connector casing, a heat-dissipating structure, and an elastic attaching part. The connector casing forms an insertion slot and has an outer side wall. The outer side wall has a window connected to the insertion slot. The heat-dissipating structure is disposed on the outer side wall and includes a heat pipe. The heat pipe is disposed outside the outer side wall and has a heat-absorbing section corresponding to the window. The heat-absorbing section extends parallel to the outer side wall and partially enters the insertion slot through the window. The elastic attaching part is engaged to the connector casing so that the heat-dissipating structure is elastically clamped by and between the elastic attaching part and the outer side wall. The heat-absorbing section can move relative to the window.

### BACKGROUND OF THE INVENTION

### 1. Field of the Invention

The present invention relates to an electrical connector, and more particularly to an electrical connector with a heat-dissipating structure.

### 2. Description of the Prior Art

Electrical connectors are used widely in applications for power or signal connection, for example for connecting an electronic host device with an external device. As the transfer rate of the electrical connector is higher and higher, the electronic connector generates more and more heat. In some instances of a plug in coordination with a socket connector, heat-dissipating fins are usually fixed on the outer shell of the socket connector for dissipating heat. However, when the plug and the socket connector are engaged with each other and are in operation, a heat source occurs substantially inside the plug. If excessive generated heat remains inside the plug, it will lead to a failure in the plug. Therefore, the heat generated inside the plug will be transferred to the outer shell of the socket connector and then be able to dissipate through the heat-dissipating fins. Furthermore, the outer shell of the socket connector does not directly contact the heat source, so the efficiency of transferring the generated heat to the outer shell of the socket connector may be not good. Therefore, the effect of dissipating heat from the connector through only the heat-dissipating fins is limited.

### SUMMARY OF THE INVENTION

The present invention provides an electrical connector cage assembly that has a heat-dissipating structure, of which a heat pipe can extend into a connector casing for enhancing the heat dissipation efficiency.

An electrical connector cage assembly according to the invention includes a connector casing, a heat-dissipating structure, and an elastic attaching part. The connector casing forms an insertion slot and has an outer side wall. The outer side wall has a window. The window is connected to the insertion slot. The heat-dissipating structure is disposed on the outer side wall and includes a heat pipe. The heat pipe is disposed outside the outer side wall and has a heat-absorbing section corresponding to the window. The heat-absorbing section extends parallel to the outer side wall and partially enters the insertion slot through the window. The elastic attaching part is engaged to the connector casing so as to elastically clamp the heat-dissipating structure between the elastic attaching part and the outer side wall. The heat-absorbing section is movable relative to the window. Thereby, when an insertion module is inserted into the insertion slot, the heat-absorbing section can be pushed by the insertion module to move relative to the outer side wall by use of the elasticity of the elastic attaching part and directly contacts the insertion module, so that the heat dissipation efficiency is enhanced.

Another objective of the present invention is to provide an electrical connector that includes one like the above electrical connector cage assembly with the heat-dissipating structure so that the heat dissipation efficiency is enhanced.

An electrical connector according to the invention includes a circuit board, an electrical connector base, and the above electrical connector cage assembly. The electrical connector cage assembly is fixed on the circuit board. The electrical connector base is electrically connected onto the circuit board in the connector casing and exposed through the insertion slot. Similarly, when an insertion module is inserted into the insertion slot and engaged with the electrical connector base, the heat-absorbing section can be pushed by the insertion module to move relative to the outer side wall by use of the elasticity of the elastic attaching part and directly contacts the insertion module, so that the heat dissipation efficiency is enhanced.

Another objective of the present invention is to provide an electronic apparatus that includes one like the above electrical connector cage assembly with the heat-dissipating structure. The heat-dissipating structure is thermally coupled to a structural side plate of an apparatus casing so as to enhance the heat dissipation efficiency.

An electronic apparatus according to the invention includes an apparatus casing, a circuit board, an electrical connector base, and the above electrical connector cage assembly. The apparatus casing forms an accommodating space and includes a structural side plate. The circuit board is disposed in the accommodating space. The electrical connector cage assembly is fixed on the circuit board. The heat pipe is thermally coupled to the structural side plate. The electrical connector base is electrically connected onto the circuit board in the connector casing and exposed through the insertion slot. Similarly, when an insertion module is inserted into the insertion slot and engaged with the electrical connector base, the heat-absorbing section can be pushed by the insertion module to move relative to the outer side wall by use of the elasticity of the elastic attaching part and directly contacts the insertion module. Thereby, the heat pipe can transfer heat received by the heat pipe to the structural side plate, so that the heat dissipation efficiency is enhanced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an electrical connector of an embodiment according to the invention.

FIG. 2 is an exploded view of the electrical connector.

FIG. 3 is a sectional view of the electrical connector along the line X-X in FIG. 1.

FIG. 4 is a schematic diagram illustrating an electronic apparatus, which is partially exploded, of an embodiment according to the invention.

FIG. 5 is an exploded view of a portion of the electronic apparatus in FIG. 4.

FIG. 6 is a sectional view of the electronic apparatus along the line Y-Y in FIG. 4.

### DETAILED DESCRIPTION

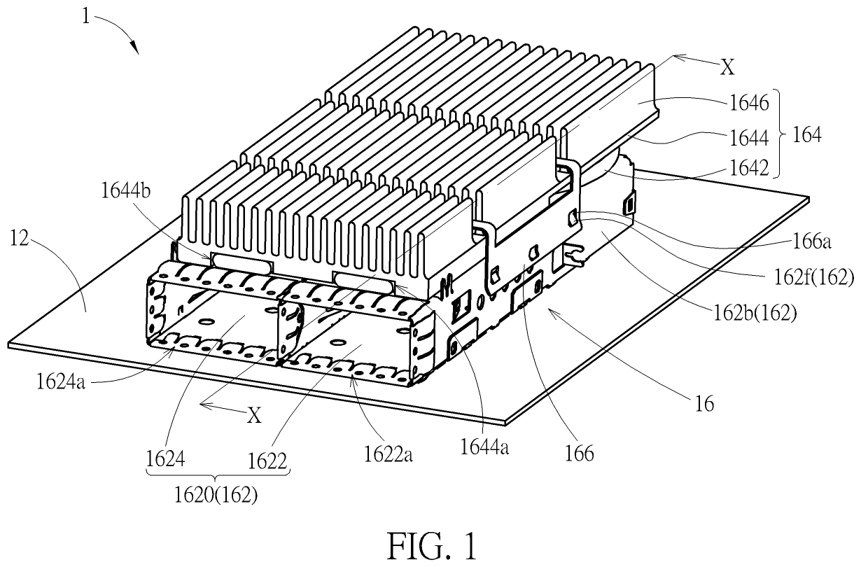

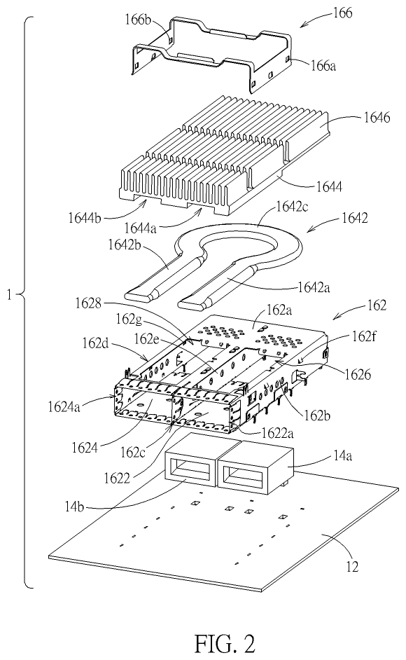

Please refer to FIG. 1 to FIG. 3. An electrical connector 1 of an embodiment according to the invention includes a circuit board 12, two electrical connector bases 14a and 14b, and an electrical connector cage assembly 16. The electrical connector cage assembly 16 is fixed on the circuit board 12. The electrical connector bases 14a and 14b are electrically connected onto the circuit board 12 in the electrical connector cage assembly 16. For simplification of drawing, the electrical connector bases 14a and 14b are shown by solid blocks in the figures. In practice, the electrical connector bases 14a and 14b can be structurally integrated to be a single component for convenience of assembly. The electrical connector cage assembly 16 includes a connector casing 162, a heat-dissipating structure 164, and two elastic attaching parts 166. The connector casing 162 has four outer side walls 162a-d and a partition plate 162e. The outer side walls 162a-d are connected together to form an accommodating space 1620. The partition plate 162e is connected to the outer side walls 162a and 162c in the accommodating space 1620 to divide the accommodating space 1620 into a first insertion slot 1622 and a second insertion slot 1624. The electrical connector bases 14a and 14b are exposed through the first insertion slots 1622 and the second insertion slot 1624 respectively. The first insertion slot 1622 has a first inlet 1622a. The second insertion slot 1624 has a second inlet 1624a. The outer side wall 162a has a first window 1626 and a second window 1628 that are connected to the first insertion slot 1622 and the second insertion slot 1624 respectively.

The heat-dissipating structure 164 is disposed on the outer side wall 162a. The elastic attaching part 166 is engaged to the connector casing 162 so that the heat-dissipating structure 164 is elastically clamped by and between the elastic attaching part 166 and the outer side wall 162a. The heat-dissipating structure 164 includes a heat pipe 1642. The heat pipe 1642 is disposed outside the outer side wall 162a and has a first heat-absorbing section 1642a, a second heat-absorbing section 1642b, and a connection section 1642c. The connection section 1642c connects the first heat-absorbing section 1642a and the second heat-absorbing section 1642b. The first heat-absorbing section 1642a is disposed corresponding to the first window 1626 and extends parallel to the outer side wall 162a and partially enters the first insertion slot 1622 through the first window 1626. The second heat-absorbing section 1642b is disposed corresponding to the second window 1628 and extends parallel to the outer side wall 162a and partially enters the second insertion slot 1624 through the second window 1628. For simplification of drawing, the heat pipe 1642 is shown by a solid block in the figure. In practice, the heat pipe 1642 can be realized by a heat pipe with a flat, ellipse profile. Two ends of the heat pipe 1642 form protruding structures respectively (e.g. by shaping the heat pipe e.g. by use of a mold). The two ends are therefore taken as the first heat-absorbing section 1642a and the second heat-absorbing section 1642b respectively. The protruding structures can enter the first insertion slot 1622 and the second insertion slot 1624 respectively. The middle portion of the heat pipe is taken as the connection section 1642c. For another example, it is practicable to use and shape three tubes to form the profiles of the first heat-absorbing section 1642a, the second heat-absorbing section 1642b, and the connection section 1642c respectively. Afterward, the above three parts are joined together to form the heat pipe 1642.

The heat-dissipating structure 164 further includes a heat-dissipating part that is thermally coupled to the heat pipe 1642. In the embodiment, the heat-dissipating part includes a base 1644 and a plurality of fins 1646 extending from the base 1644. The base 1644 is thermally coupled to the heat pipe 1642. The base 1644 has a first recess 1644a and a second recess 1644b. The first heat-absorbing section 1642a is accommodated in the first recess 1644a. The second heat-absorbing section 1642b is accommodated in the second recess 1644b. In practice, the first heat-absorbing section 1642a and the second heat-absorbing section 1642b can be fixed in the first recess 1644a and the second recess 1644b by soldering. For example, the gap between the first recess 1644a and the first heat-absorbing section 1642a is filled with solder. Furthermore, the connection section 1642c also can be fixed on the base 1644 by soldering. In practice, the fixing also can be implemented by glue or thermal pad, which will not be described in addition.

The elastic attaching part 166 crosses the heat-dissipating structure 164 and engages with the outer side walls 162b and 162d. In the embodiment, the elastic attaching part 166 shows an n-shaped structure substantially, of which two ends has two lock holes 166a and 166b. The outer side walls 162b and 162d have two hooks 162f and 162g correspondingly. By the hooks 162f and 162g hooking the lock holes 166a and 166b respectively, the elastic attaching part 166 is detachably engaged to the outer side walls 162b and 162d. In practice, the elastic attaching part 166 can be engaged to the connector casing 162 in a way that one end portion of the elastic attaching part 166 is pivotally connected to the connector casing 162 and the other end portion thereof hooks the connector casing 162, for installing the heat-dissipating structure 164 to the connector casing 162. Furthermore, in the embodiment, the elastic attaching part 166 passes through the plurality of fins 1646. The heat-dissipating structure 164 is elastically clamped between the elastic attaching part 166 and the outer side wall 162a. From another aspect, the fins 1646 are not disposed on the portion of the base 1644 corresponding to the elastic attaching part 166. The middle portion of the elastic attaching part 166 connecting the two end portions can directly abut against the base 1644. By use of the elasticity of the elastic attaching part 166, the clamped heat-dissipating structure 164 can be forced to move (or float) in design. In other words, the first heat-absorbing section 1642a can move relative to the first window 1626. The second heat-absorbing section 1642b can move relative to the second window 1628.

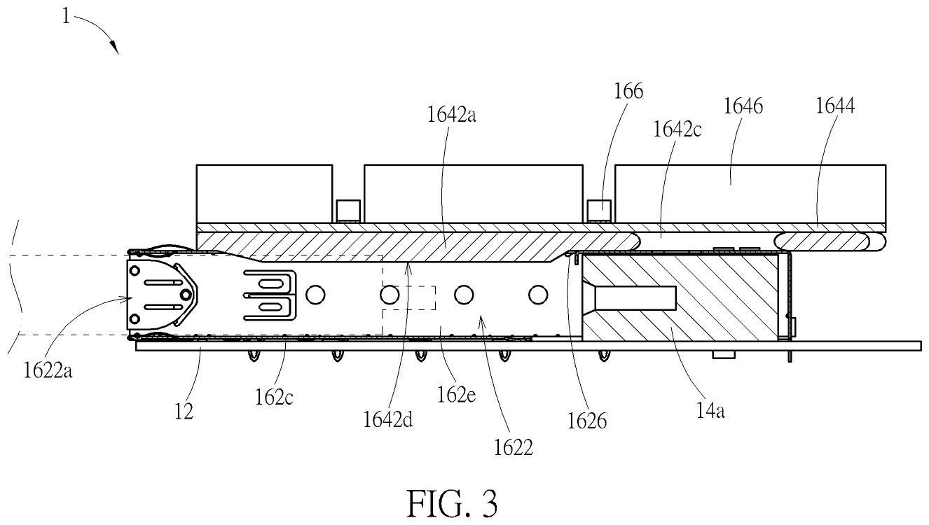

For example, during the process of inserting an insertion module (i.e. a mating connector with the electrical connector 1, which is shown by a dashed rectangle in FIG. 3), that matches the electrical connector base 14a, from the first inlet 1622a into the first insertion slot 1622 to engage with the electrical connector base 14a, because the first heat-absorbing section 1642a is partially disposed in the first insertion slot 1622, the insertion module can contact and push the first heat-absorbing section 1642a so that the first heat-absorbing section 1642a moves outward relative to the first window 1626 (i.e. moving upward in FIG. 3, or moving perpendicular to the extension direction of the outer side wall 162a). Also by use of the elasticity of the elastic attaching part 166, the contact force between the first heat-absorbing section 1642a and the insertion module can be maintained in a certain degree, which is conducive to the heat transfer between the insertion module and the first heat-absorbing section 1642a. In the embodiment, the portion of the first heat-absorbing section 1642a that enters the first insertion slot 1622 has a flat contact surface 1642d matching with the profile of the insertion module, which is conducive to the heat transfer between the insertion module and the first heat-absorbing section 1642a. The above description is also applicable to the second heat-absorbing section 1642b and will not be repeated. Furthermore, by use of the phase change of working fluid of the heat pipe 1642, heat can be rapidly transferred by the heat pipe 1642 from the insertion module to the base 1644 and then dissipate out through the fins 1646.

In the embodiment, the heat-dissipating structure 164 is installed on the upper side of the connector casing 162 (i.e. the outer side wall 162a) in accordance with the arrangement of the first insertion slot 1622 and the second insertion slot 1624 (i.e. horizontally arranged). In practice, if the first insertion slot 1622 and the second insertion slot 1624 are arranged vertically, the heat-dissipating structure 164 can be installed on the left or right side of the connector casing 162 (i.e. the outer side wall 162d or the outer side wall 162b) accordingly. Furthermore, in the embodiment, the electrical connector 1 is illustrated with two insertion slots. The heat-dissipating structure 164 performs heat dissipation to both the first insertion slot 1622 and the second insertion slot 1624. However, the electrical connector 1 is not limited thereto in practice. As described in the foregoing, the heat pipe 1642 partially enters the first insertion slot 1622 through the first window 1626, so that the heat pipe 1642 can directly contact the insertion module so as to rapidly transfer heat from the insertion module to the heat-dissipating part (which includes the base 1644 and the plurality of fins 1646 in the embodiment) and dissipate the heat. Therefore, in practice, the configuration is applicable to an electrical connector with a single insertion slot or more insertion slots. This electrical connector may involve modifications of its structure in practice, which can be realized based on the embodiment and the relevant descriptions in the foregoing and will not be described in detail. For example, the heat-dissipating structure 164 can be provided without the base 1644 and the fins 1646 thereon; a plurality fins (e.g. copper sheets, of which the central portion has a through hole for the connection section 1642c to pass through) are sleeved on the connection section 1642c as a heat-dissipating part. For another example, in an electrical connector with a single insertion slot, the heat pipe thereof uses one end portion to absorb heat from an insertion module, and a plurality fins are sleeved on the other end portion of the heat pipe as a heat-dissipating part without a base.

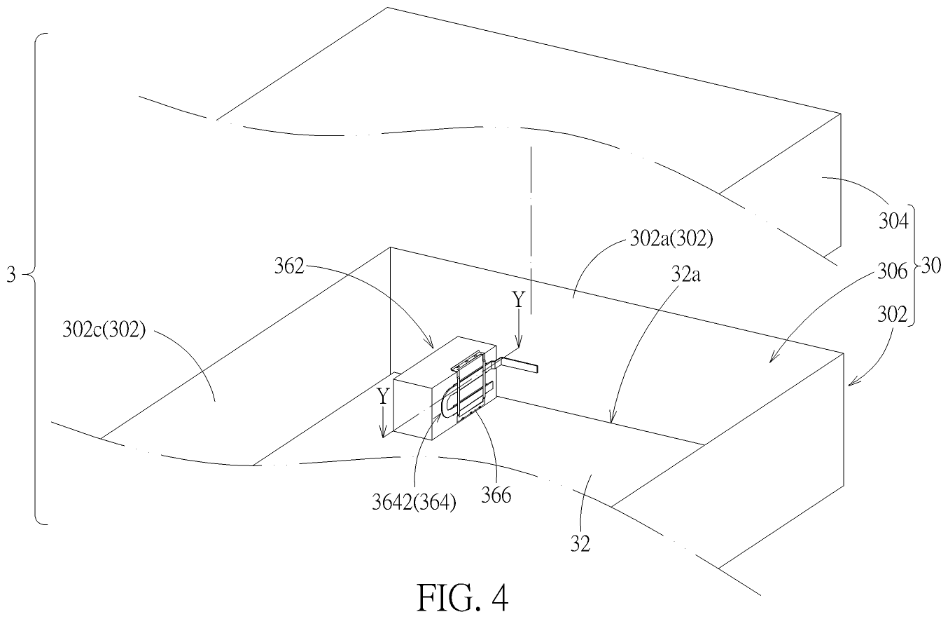

Please refer to FIG. 4 to FIG. 6. An electronic apparatus 3 of an embodiment according to the invention includes an apparatus casing 30, a circuit board 32, two electrical connector bases 34a and 34b, and an electrical connector cage assembly 36. The apparatus casing 30 includes a lower casing 302 and an upper casing 304. The lower casing 302 and the upper casing 304 are engaged to form an accommodating space 306. The circuit board 32 (for example but not limited to a system main board of the electronic apparatus 3) is disposed in the accommodating space 306. The electrical connector cage assembly 36 is fixed on the circuit board 32. The electrical connector bases 34a and 34b are electrically connected onto the circuit board 32 and located in the electrical connector cage assembly 36. The electrical connector cage assembly 36 includes a connector casing 362, a heat-dissipating structure 364, and two elastic attaching parts 366. The connector casing 362 has four outer side walls 362a-d and a partition plate 362e. The outer side walls 362a-d are connected together to form an accommodating space 3620. The partition plate 362e is connected to the outer side walls 362b and 362d in the accommodating space 3620 to divide the accommodating space 3620 into a first insertion slot 3622 and a second insertion slot 3624. The electrical connector bases 34a and 34b are exposed through the first insertion slot 3622 and the second insertion slot 3624 respectively. The first insertion slot 3622 has a first inlet 3622a. The second insertion slot 3624 has a second inlet 3624a. The outer side wall 362d has a first window 3626 and a second window 3628 that communicate with the first insertion slot 3622 and the second insertion slot 3624 respectively. In the embodiment, the first insertion slot 3622 and the second insertion slot 3624 are arranged vertically. The electrical connector bases 34a and 34b are structurally integrated into a single component, however, which is not limited thereto in practice.

The heat-dissipating structure 364 is disposed on the outer side wall 362d. The elastic attaching part 366 is engaged to the connector casing 362 so that the heat-dissipating structure 364 is elastically clamped by and between the elastic attaching part 366 and the outer side wall 362d. In the embodiment, one end portion of the elastic attaching part 366 is pivotally connected to the connector casing 362. The other end portion thereof hooks the connector casing 362. In practice, it is practicable for the elastic attaching part 366 to be engaged with the connector casing 362 in the same way as the engagement of the elastic attaching part 166 with the connector casing 162, which will not be described in addition. The heat-dissipating structure 364 includes a heat pipe 3642. The heat pipe 3642 is disposed outside the outer side wall 362d and has a first heat-absorbing section 3642a, a second heat-absorbing section 3642b, a connection section 3642c, and an extension section 3642d. The connection section 3642c connects the first heat-absorbing section 3642a and the second heat-absorbing section 3642b. The extension section 3642d extends from an end of the first heat-absorbing section 3642a. The first heat-absorbing section 3642a extends parallel to the outer side wall 362d and partially enters the first insertion slot 3622 through the first window 3626. The second heat-absorbing section 3642b extends parallel to the outer side wall 362d and partially enters the second insertion slot 3624 through the second window 3628. For the details of the first heat-absorbing section 3642a and the second heat-absorbing section 3642b, please refer to the relevant descriptions of the first heat-absorbing section 1642a and the second heat-absorbing section 1642b in the foregoing, which will not be described in addition.

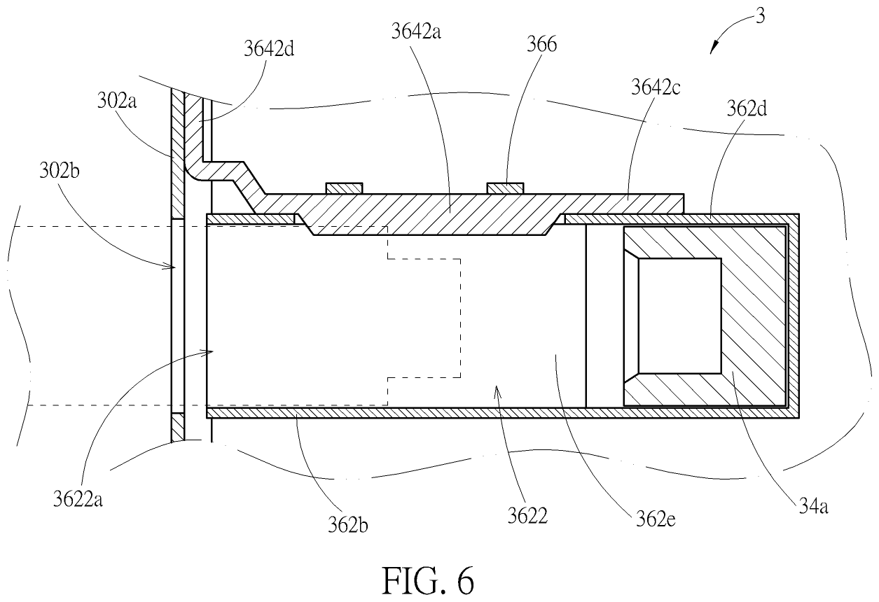

Similarly, the elastic attaching part 366 will produce elastic structural constraint on the heat pipe 3642. The elastic structural constraint is the same as that produced by elastic attaching part 166 on the heat pipe 1642 and will not be repeatedly described. Furthermore, the portions of the heat pipe 3642 that enter the first insertion slot 3622 and the second insertion slot 3624 have a flat contact surface that matches the profile of an insertion module (shown by a dashed rectangle in FIG. 6) used for being inserted into the first insertion slot 3622 and the second insertion slot 3624, which is conducive to the heat transfer between the insertion module and the heat pipe 3642. In addition, in practice, the heat-dissipating structure 364 also can include a base and a plurality of fins extending from the base. The heat pipe 3642 is thermally coupled to the base (e.g. as shown by the configuration of the base 1644, the fins 1646, and the heat pipe 1642), for enhancing the heat dissipation efficiency.

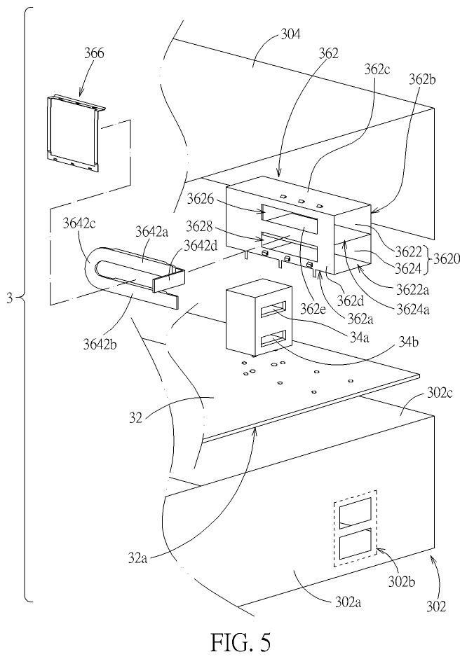

Furthermore, in the embodiment, the connector casing 362 is located at a side edge 32a of the circuit board 32. The lower casing 302 has a structural side plate 302a adjacent to the side edge 32a. The first inlet 3622a and the second inlet 3624a face the structural side plate 302a. The structural side plate 302a has a through hole structure 302b (indicated by a dashed rectangle in FIG. 5, for example including two through holes corresponding to the first inlet 3622a and the second inlet 3624a), so that the first inlet 3622a and the second inlet 3624a are exposed through the through hole structure 302b. The extension section 3642d of the heat pipe 3642 is thermally coupled to the structural side plate 302a (e.g. by soldering). Heat absorbed by the first heat-absorbing section 3642a and the second heat-absorbing section 3642b can be transferred through the extension section 3642d to the structural side plate 302a to dissipate. In practice, it is practicable for the extension section 3642d to be thermally coupled to other structural side plate of the lower casing 302 (e.g. the structural side plate 302c), which also can perform the heat dissipation through the apparatus casing 30.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrical connector cage assembly, comprising:
a connector casing, forming a first insertion slot and having an outer side wall, the outer side wall having a first window, the first window being connected to the first insertion slot;
a heat-dissipating structure, disposed on the outer side wall and comprising a heat pipe, the heat pipe being disposed outside the outer side wall and having a first heat-absorbing section corresponding to the first window, the first heat-absorbing section extending parallel to the outer side wall and partially entering the first insertion slot through the first window; and
an elastic attaching part, engaged to the connector casing so as to elastically clamp the heat-dissipating structure between the elastic attaching part and the outer side wall, the first heat-absorbing section being movable relative to the first window.

2. The electrical connector cage assembly of claim 1, wherein the portion of the first heat-absorbing section that enters the first insertion slot has a flat contact surface.

3. The electrical connector cage assembly of claim 1, wherein the heat-dissipating structure comprises a heat-dissipating part, and the heat-dissipating part is thermally coupled to the heat pipe.

4. The electrical connector cage assembly of claim 3, wherein the heat-dissipating part comprises a base and a plurality of fins extending from the base, the base is thermally coupled to the heat pipe, the base has a first recess, and the first heat-absorbing section is accommodated in the first recess.

5. The electrical connector cage assembly of claim 4, wherein the elastic attaching part passes through the plurality of fins.

6. The electrical connector cage assembly of claim 1, wherein the connector casing forms a second insertion slot, the outer side wall has a second window, the second window is connected to the second insertion slot, the heat pipe has a second heat-absorbing section and a connection section, the connection section connects the first heat-absorbing section and the second heat-absorbing section, and the second heat-absorbing section is disposed corresponding to the second window, extends parallel to the outer side wall and partially enters the second insertion slot through the second window.

7. The electrical connector cage assembly of claim 6, wherein the heat-dissipating structure comprises a heat-dissipating part, the heat-dissipating part comprises a base and a plurality of fins extending from the base, the heat-dissipating part is thermally coupled to the heat pipe through the base, the base has a second recess, and the second heat-absorbing section is accommodated in the second recess.

8. An electrical connector, comprising:
a circuit board;
an electrical connector cage assembly, fixed on the circuit board, the electrical connector cage assembly comprising:
a connector casing, forming a first insertion slot and having an outer side wall, the outer side wall having a first window, the first window being connected to the first insertion slot;
a heat-dissipating structure, disposed on the outer side wall and comprising a heat pipe, the heat pipe being disposed outside the outer side wall and having a first heat-absorbing section corresponding to the first window, the first heat-absorbing section extending parallel to the outer side wall and partially entering the first insertion slot through the first window; and
an elastic attaching part, engaged to the connector casing so as to elastically clamp the heat-dissipating structure between the elastic attaching part and the outer side wall, the first heat-absorbing section being movable relative to the first window; and
an electrical connector base, electrically connected onto the circuit board in the connector casing and exposed through the first insertion slot.

9. The electrical connector of claim 8, wherein the portion of the first heat-absorbing section that enters the first insertion slot has a flat contact surface.

10. The electrical connector of claim 8, wherein the heat-dissipating structure comprises a heat-dissipating part, and the heat-dissipating part is thermally coupled to the heat pipe.

11. The electrical connector of claim 10, wherein the heat-dissipating part comprises a base and a plurality of fins extending from the base, the base is thermally coupled to the heat pipe, the base has a first recess, and the first heat-absorbing section is accommodated in the first recess.

12. The electrical connector of claim 11, wherein the elastic attaching part passes through the plurality of fins.

13. The electrical connector of claim 8, wherein the connector casing forms a second insertion slot, the outer side wall has a second window, the second window is connected to the second insertion slot, the heat pipe has a second heat-absorbing section and a connection section, the connection section connects the first heat-absorbing section and the second heat-absorbing section, and the second heat-absorbing section is disposed corresponding to the second window, extends parallel to the outer side wall and partially enters the second insertion slot through the second window.

14. The electrical connector of claim 13, wherein the heat-dissipating structure comprises a heat-dissipating part, the heat-dissipating part comprises a base and a plurality of fins extending from the base, the heat-dissipating part is thermally coupled to the heat pipe through the base, the base has a second recess, and the second heat-absorbing section is accommodated in the second recess.

15. An electrical apparatus, comprising:
an apparatus casing, forming an accommodating space and comprising a structural side plate;
a circuit board, disposed in the accommodating space;
an electrical connector cage assembly, fixed on the circuit board, the electrical connector cage assembly comprising:
a connector casing, forming a first insertion slot and having an outer side wall, the outer side wall having a first window, the first window being connected to the first insertion slot;
a heat-dissipating structure, disposed on the outer side wall and comprising a heat pipe, the heat pipe being disposed outside the outer side wall and being thermally coupled to the structural side plate, the heat pipe having a first heat-absorbing section corresponding to the first window, the first heat-absorbing section extending parallel to the outer side wall and partially entering the first insertion slot through the first window; and
an elastic attaching part, engaged to the connector casing so as to elastically clamp the heat-dissipating structure between the elastic attaching part and the outer side wall, the first heat-absorbing section being movable relative to the first window; and
an electrical connector base, electrically connected onto the circuit board in the connector casing and exposed through the first insertion slot.

16. The electrical apparatus of claim 15, wherein the portion of the first heat-absorbing section that enters the first insertion slot has a flat contact surface.

17. The electrical apparatus of claim 16, wherein the connector casing is located at a side edge of the circuit board, and the structural side plate is adjacent to the side edge.

18. The electrical apparatus of claim 15, wherein the connector casing forms a second insertion slot, the outer side wall has a second window, the second window is connected to the second insertion slot, the heat pipe has a second heat-absorbing section and a connection section, the connection section connects the first heat-absorbing section and the second heat-absorbing section, and the second heat-absorbing section is disposed corresponding to the second window, extends parallel to the outer side wall and partially enters the second insertion slot through the second window.

19. The electrical apparatus of claim 18, wherein the connector casing is located at a side edge of the circuit board, and the structural side plate is adjacent to the side edge.
